(19) United States
(12) Patent Application Publication
(10) Pub. No.: US 2006/0092458 A1
(43) Pub. Date: May 4, 2006

(54) Allocation of data-encoding pattern

(75) Inventors: Jose Abad Peiro, Sant Cugat (ES); Manuel Gonzalez, Malaga (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/250,487

(22) Filed: Oct. 17, 2005

(30) Foreign Application Priority Data
Oct. 28, 2004 (GB) 0423909.1

(51) Int. Cl. G06F 3/12

(52) U.S. Cl. 358/1.15

(57) ABSTRACT

A system for controlling allocation of areas of data-encoding pattern from a defined pattern space, the system comprises a service provider system 304; a user system 302; and a certification system 308. The certification system is arranged to certify a token, and the service provider system is arranged to issue the certified token to the user system thereby authorising the user to use an area of the pattern.

### FIELD OF THE INVENTION

The present invention relates to the allocation and distribution of data-encoding pattern

### BACKGROUND TO THE INVENTION

It is known to provide data encoding pattern on products, for example documents, so that a hand held device, such as a pen, can read the data encoded in the pattern and use it, for example, to detect its position as it is moved over the document. Where the hand held device is a pen arranged to mark the product, the position of marks made on the documents can be detected by the pen, thereby enabling the position of the marks on the document to be stored electronically as they are made.

The data encoding pattern can be thought of as defining an area of pattern space, such that the pattern from any one area of pattern space, assuming it is of at least a certain size, is unique. For such a system to work, there needs to be a system for recording which areas of pattern have been used for which documents. Also because available pattern space is limited per user, it is useful if pattern can be re-used. For example it can be allocated to a particular document, and then, when that document is no longer needed, the pattern space can be re-allocated to a different document.

### SUMMARY OF THE INVENTION

The present invention provides a system for controlling allocation of areas of data-encoding pattern from a defined pattern space, the system comprising: a service provider system; and a certification system; wherein the certification system is arranged to certify a token, and the service provider system is arranged to issue the certified token to a user thereby authorising the user to use an area of the pattern.

The present invention further provides a system for producing encrypted pattern for application to a product, the system being arranged to allocate an area of pattern to a document, encrypt data defining the area of pattern so that it defines an area of encrypted pattern, and send the encrypted data to a printing system so that the encrypted pattern can be printed on the product.

The present invention further provides a system for interpreting pen stroke data produced using a pen on a product which has encrypted data encoding pattern on it, the system being arranged to receive the pen stroke data, decrypt the pen stroke data, and process the decrypted pen stroke data.

Corresponding methods are also provided.

The present invention further provides a data carrier carrying data arranged to control relevant systems to operate as a system according to the invention and to perform the methods of the invention. The data carrier can comprise, for example, a floppy disk, a CDROM, a DVD ROM/RAM (including +RW, -RW), a hard drive, a non-volatile memory, any form of magneto optical disk, a wire, a transmitted signal (which may comprise an internet download, an ftp transfer, or the like), or any other form of computer readable medium.

Preferred embodiments of the present invention will now be described by way of example only with reference to the accompanying drawings.

### BRIEF DESCRIPTION OF THE DRAWINGS

FIG. 1 is a schematic view of a document having data encoding pattern thereon;

FIG. 2 shows the pattern on the document of FIG. 1 in more detail;

FIG. 3 is a schematic representation of a system according to an embodiment of the invention for producing and processing the document of FIG. 1;

FIG. 4 is a schematic view of a pen forming part of the system of FIG. 3;

FIG. 5 is a block diagram of the functional features of the PC forming part of the system of FIG. 3;

FIG. 6 is a schematic diagram showing operation of the system of FIG. 3; and

FIG. 7 is a schematic diagram showing further aspects of the operation of the system of FIG. 3.

### DESCRIPTION OF THE PREFERRED EMBODIMENTS

Referring to FIG. 1 a document 100 for use in a digital pen and paper system comprises a carrier 102 in the form of a single sheet of paper 104 with position identifying markings 106 printed on some parts of it to form areas 107 of a position identifying pattern 108. Also printed on the paper 104 are further markings 109 which are clearly visible to a human user of the form, and which make up the content of the document 100. The content 109 will obviously depend entirely on the intended use of the document. In this case an example of a very simple two page questionnaire is shown, and the content includes a number of boxes 110, 112 which can be pre-printed with user specific information such as the user's name 114 and a document identification number 116. The content further comprises a number of check boxes 118 any one of which is to be marked by the user, and two larger boxes 120, 121 in which the user can write comments. The form content also includes a send box 122 to be checked by the user when he has completed the questionnaire to initiate a document completion process by which pen stroke data is forwarded for processing, and typographical information on the form such as the headings or labels 124 for the various boxes 110, 112, 118, 120. The position identifying pattern 108 is only printed onto the parts of the form which the user is expected to write on or mark, that is within the check boxes 118, the comments boxes 120, 121 and the send box 122.

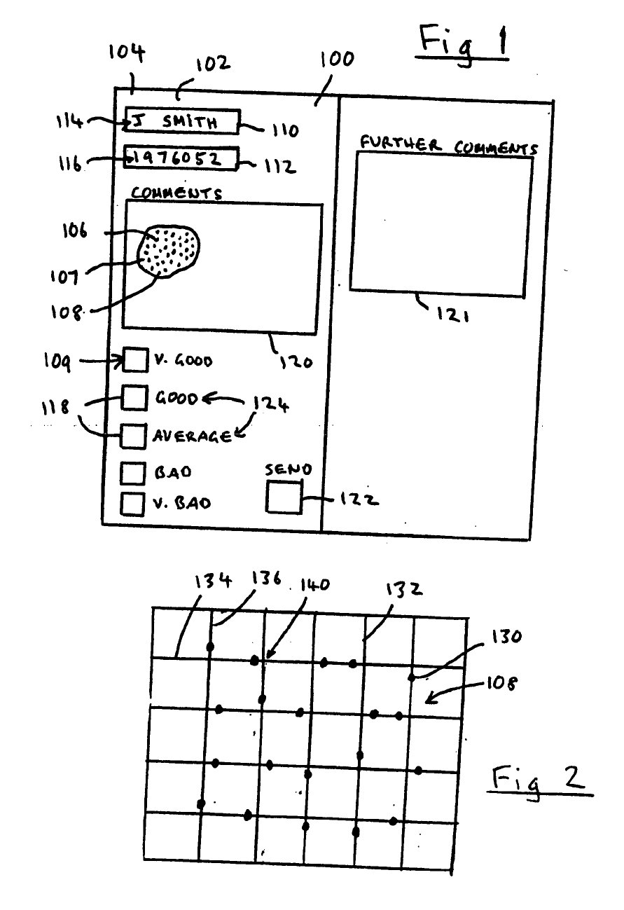

Referring to FIG. 2, the position identifying pattern 108 is made up of a number of dots 130 arranged on an imaginary grid 132. The grid 132 can be considered as being made up of horizontal and vertical lines 134, 136 defining a number of intersections 140 where they cross. The intersections 140 are of the order of 0.3 mm apart, and the dots are of the order of 100 μm across. One dot 130 is provided at each intersection 140, but offset slightly in one of four possible directions up, down, left or right, from the actual intersection 140. The dot offsets are arranged to vary in a systematic way so that any group of a sufficient number of dots 130, for example any group of 36 dots arranged in a six by six square, will be unique within a very large area of the pattern. This large area is defined as a total imaginary pattern space, and only a small part of the pattern space is taken up by the pattern on the document 100. By allocating a known area of the pattern space to the document 100, for example by means of a co-ordinate reference, the document and any position on the patterned parts of it can be identified from the pattern printed on it. An example of this type of pattern is described in WO 01/26033. It will be appreciated that other position identifying patterns can equally be used. Some examples of other suitable patterns are described in WO 00/73983 and WO 01/71643.

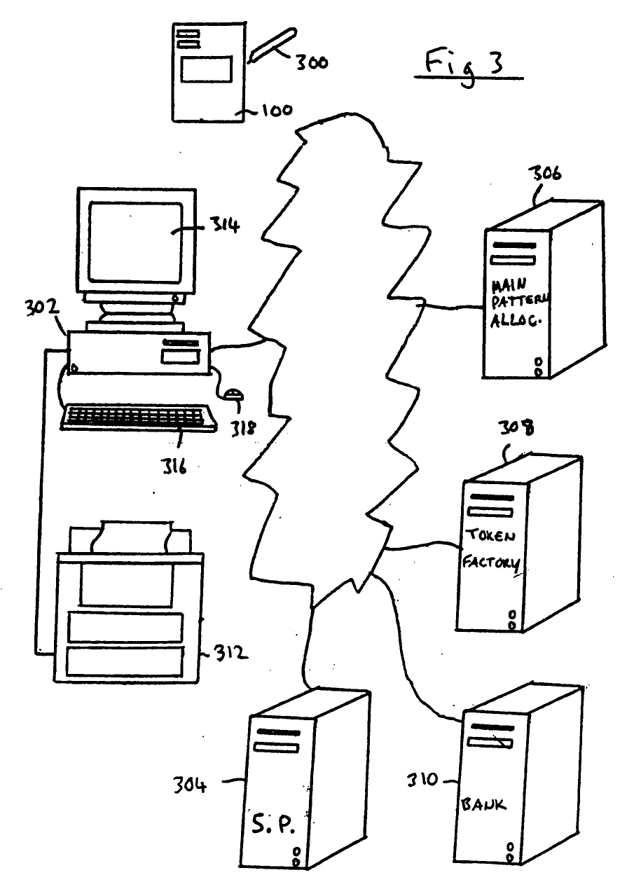

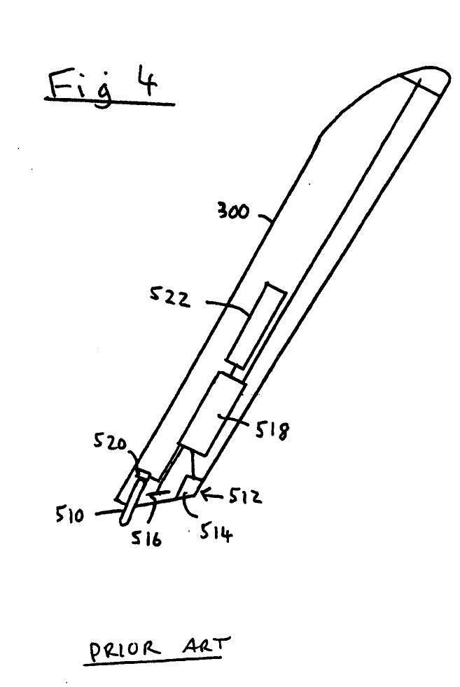

Referring to FIG. 3 an internet based system for using the document 100 comprises a pen 300 arranged to write on the document 100 and to detect its position on the document from the pattern 108, and an internet connected personal computer (PC) 302 arranged to run an application for processing data from the pen 300, for example by modifying a file in which the document 100 is stored electronically in response to pen strokes made on the document 100 with the pen 300. The PC 302 includes a user interface including a screen 314, a keyboard 316 and a mouse 318, as well as a processor, a memory, and I/O software devices by means of which the processor communicates with the screen 314, the keyboard 316, the mouse 318 and a communications port by means of which it communicates with the internet. The user interface 412 is also shown in FIG. 4. The PC 302 is connected to a printer 312 on which it can print documents 100.

The system further comprises a service provider 304 in the form of an internet connected server that is arranged to allocate areas of pattern space to individual documents, and to keep a record of which pattern space areas are allocated to which documents. The service provider 304 can allocate pattern to a large number of user systems similar to the PC 302, which is therefore only shown as an example. A main pattern allocation server 306, also internet connected, also forms part of the system. This server 306 is arranged to allocate large areas of pattern space to the service provider 304, and other service providers. A token factory 308 also forms part of the system. This is a nominally independent entity that can ensure the security of the exchanges of pattern area between the service provider 304 and the user system 302. This entity acts as a trusted third party for the user 302 and the community of potential readers of the document 100. Finally the system includes a bank 310 that is arranged to enable monetary transactions over the internet using known e-commerce systems. The token factory 308 can check the legitimacy of signatures or other credentials of the user 302 and other users, and the service provider, and can send encrypted data to the service provider 304 and users, as it has access to public keys of the users and service provider. The functions of the token factory 308 will be described in more detail below.

It will be understood that the various components of the system can all be located at separate locations, communicating via the internet as described. Alternatively some or all of them could be provided together on a single server, or grouped on a local network. This might be appropriate where a self-contained system for a limited number of applications is required.

Referring to FIG. 4, the pen 300 comprises a writing nib 510, and a camera 512 made up of an infra red (IR) LED 514 and an IR sensor 516. The camera 512 is arranged to image a circular area adjacent to the tip 511 of the pen nib 510. A processor 518 processes images from the camera 512 taken at a predetermined rapid sample rate. A pressure sensor 520 detects when the nib 510 is in contact with the document 100 and triggers operation of the camera 512. Whenever the pen is being used on a patterned area of the document 100, the processor 518 can therefore determine from the pattern 108 the position of the nib of the pen whenever it is in contact with the document 100. From this it can determine the position and shape of any marks made on the patterned areas of the document 100. This information is stored in a memory 520 in the pen as it is being used. When the user has finished marking the document, in this case when the questionnaire is completed, this is recorded in a document completion process, for example by making a mark with the pen in the send box 122. The pen is arranged to recognise the pattern in the send box 122 and determine from that pattern the identity of the document 100. It then sends this document identification information to the service provider 304 which is arranged to determine from the pen stroke data the type of document that the pen stroke data relates to, to convert it to a suitable format for input to the application 402, and to return it to the PC 302. The pen 300 can be connected to the network in any suitable manner, but in this case it is via a Bluetooth radio link with the PC 302. Suitable pens are available from Logitech under the trade mark Logitech Io.

Referring to FIG. 5, which shows the functional units of the PC 302, printing of documents 100 is controlled by a print on demand (PoD) tool 400, which is arranged to receive print demands from an application 402, and to send print instructions to a print engine in the printer 312 via a printer driver 406 on the PC 302. The PoD tool 400 is also arranged to communicate with the service provider 304 to obtain pattern for printing onto the document 100 as will be described in detail below. In this case the PoD tool 400 takes the form of software in a printer filter driver within the PC 302. However, it could incorporated in firmware in the printer 308.

The application 402 is arranged to create, design, modify, and process documents such as the questionnaire document 100 shown in FIG. 1. It therefore has access to a number of document templates 410, which are stored in the memory 403 of the PC 302. The templates 410 include content that is in PDF (Portable Document Format as defined by Adobe), and pattern information which includes the number of separate pattern areas required for the document type, and the dimensions of those areas, stored in a suitable format such as XML. Other meta-information can also be included in the document templates. The templates each correspond to a separate document name, and one of the templates 410 forms the basis for the document 100.

The PC's user interface 412 allows a user to view documents using the application 402 on the screen 314 of the PC 302, to prepare them for printing. The application 402 has access to a database 414 of data, such as user names 114 and identification numbers 116, which will need to be associated with each particular document 100 and printed out with the document 100 as pre-filled data. This database 414 may be on the PC or elsewhere on the network.

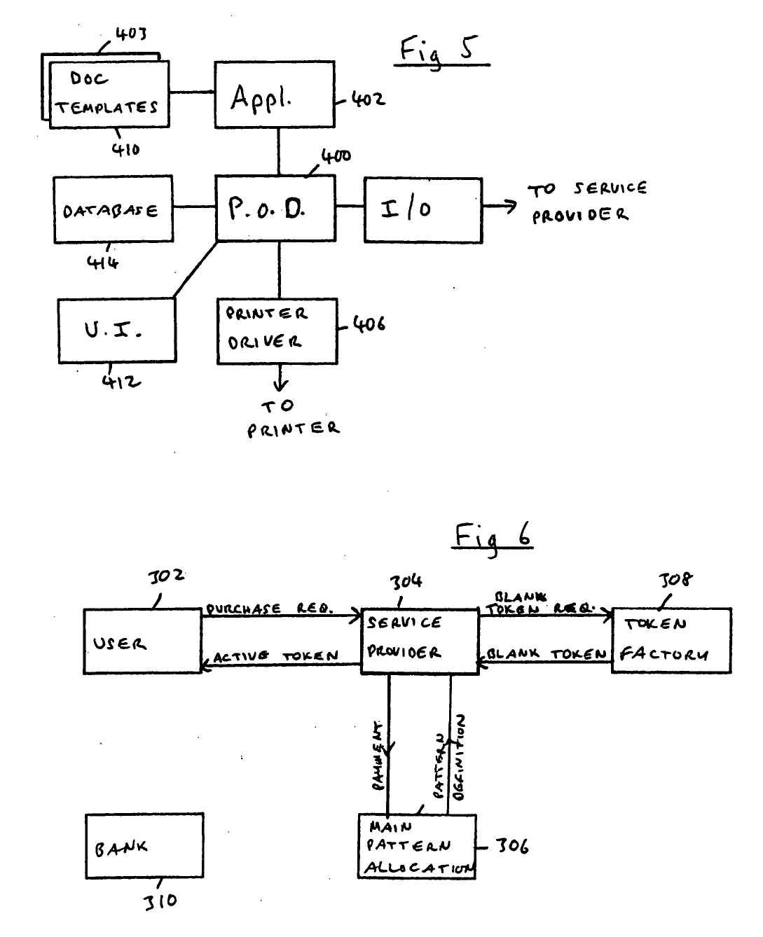

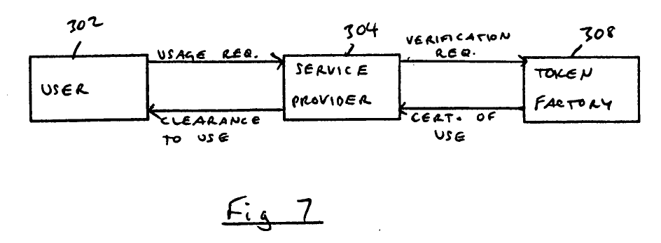

Referring to FIG. 6, when the service provider 304 is set up it purchases a large area of pattern space from the operator of the main allocation server 306. This involves making payment, in this case electronically to the account of the operator of the main pattern allocation server 306 at the bank 310, and receiving in return an electronic definition of an area of pattern space. In this case the definition is in the form of coordinates defining the allocated pattern space. The service provider 304 has a copy of the algorithm that generates the pattern, and can therefore generate the pattern corresponding to the area of pattern space defined. However, the definition sent to the service provider could take other forms, for example including a complete graphical representation of the whole area of pattern. The service provider 304 records a definition of the allocated pattern area, and then controls allocation of parts of that area to individual users and individual documents using a system of tokens.

When the user wants to be able to print documents 100 having the pattern on them, it first purchases tokens from the service provider 304 that entitle it to use certain amounts of pattern under certain conditions. To purchase a token, the user 302 sends to the service provider, using the print-on-demand tool 400, a token purchase request. This includes an indication of the number of tokens required, or the amount of pattern space that is required to be allocated, for example a number of pages of pattern space. It also includes the number of documents that each token is to be valid for, a user's ID that uniquely identifies the user, and a service ID that identifies the service that is to be provided by the service provider and the token factory, and that is associated with the document to be printed. It also includes a payment ID that identifies the user's payment means, such as a credit card number. All communication between the user 302 and the service provider 304 is secured by appropriate cryptographic certificates or signatures. The service provider 304 receives the token purchase request from the user 302 and responds by sending a blank token request to the token factory 308. The blank token request includes a description of the requirements from the user 302, e.g. the number of pages to print and the application associated with the documents to be printed. The token request also includes a class ID that identifies the context of the transaction, for example who is to use the document and when it can be used, the service ID, and a provider ID identifying the service provider 304.

The token factory 308 responds by issuing a blank token to the service provider 304. The blank token is digitally signed using the token factory's private signature key, which is part of an asymmetric public key/private key pair. This makes it statistically unlikely that the token can be forged, and it is therefore, at least to a degree, unforgeable. It will be appreciated that the level of security of the token can be determined by the complexity of the private signature key, and can be selected so as to be suitable for any particular application. The blank token also includes a token ID that indicates uniquely the blank token, an expiry date after which it cannot be validly used, a record of its creation time, the class ID, the service ID, the provider ID which identifies the service provider 304, and a verification URL which is the URL of the token factory 308. Other information can also be included to increase the efficiency of the service provided by the token factory.

The service provider 304 then converts the blank token to an active token. To do this it appends specific token details to the blank token. These include a validity period, during which the token can be used, i.e. during which the service provider 304 will provide a service in response to submission of the token. They also include purchase conditions which specify a set of restrictions applied to the promise of service embodied by the token and granted by the usage of the token factory 308. These might define a specific service ID which can include a public reference to the service provided by the token factory 308 such as a non-repudiation service used to ensure non-repudiation of contracts between the service provider 304 and the user 302 (and other users). They can also include another public reference to the application associated with, and arranged to handle, the documents to be printed using the pattern. The details also include personalisation conditions that ensure that only specific customers are able to spend the tokens. These include a definition of the customers that can use the tokens, which can include a definition of one or more email addresses, membership or account numbers, customer names, addresses or postal codes, or cookie information. These may have been specified in the purchase request from the user. Other conditions of use may also be defined within the blank token. The token is also arranged to provide a human readable description of the token's attributes, either by having the description included directly in the token, or by including a URL for text or an image which provide this information. The service provider also digitally signs the token by applying its own private signature key to it. The token is then forwarded by the service provider 304 to the user system 302, where it is stored by the print-on-demand tool 400.

Referring to FIG. 7, when the user wishes to print a document having the position identifying pattern on it, a document template 410 is selected, a document is created from the template, and modified if applicable using the application 402, and then sent for printing using the application 402. The print-on-demand tool 400 then responds to the print request by contacting the service provider 304 to obtain the required pattern, and combining the obtained pattern with the document content and printing it.

Specifically the print-on-demand tool has access to the tokens that have been purchased. To obtain pattern to print a document, the print-on-demand tool 410 presents the token to the service provider 304 as a usage request, which includes the identity of the document to be printed, and the identity of the user. The service provider checks the integrity of the token by verifying the token factory's digital signature using the token factory's public key. The service provider then also checks whether the conditions of use attached to the token are met, i.e. that the token is valid for use by the user at the time the service is requested. If all the conditions are met the service provider 304 sends a verification request to the token factory 308. The verification request includes the blank token core that has been extracted from the token, and therefore does not include most of the other parts of the token that have been added to the core by the service provider to produce the active token. The verification request also includes a request ID, added to it by the service provider 304, or by the user 302, or by another user who wants to print the document using the token. This ensures that, if the token is valid for more than one use, or used from another location (for example by a user having two PCs) the token factory can distinguish each request and therefore determine how many times the token has been used. This also enables the token factory to trace the requests, so that it can prevent re-use of the token.

The token factory receives the verification request and responds by issuing a certificate of use. This is specific to the token for which the usage request was made, and includes the blank token core, as well as a time stamp indicating when it was issued. The certificate of use is digitally signed using the token factory's private key and includes an indication of the number of times that the token has been used previously, in this case by indicating the number of verification requests received for that token, and hence the number of certificates of use previously issued for it. It also includes the request ID, for the request to which it relates. It also includes information about the usage of the service and the context of that usage.

The service provider 304 determines, on the basis of the certificate of use, whether to grant authorisation for the service to be used or not. In order to do this it checks the number of uses that the token was initially valid for, and the number of times that it has been used already. If it is still valid for one or more further uses, the service provider issues a clearance to use. This includes the electronic token against which the request was made, the request ID of the request to which it relates, a digital signature made using the service provider's private key, and an indication of the number of uses for which the token will be valid, after the requested use has been made.

Together with the clearance to use, the service provider 304 sends to the user a definition of the pattern that can be used for the document or documents that it intends to print, and that were identified in the usage request. It also records which specific area of pattern has been allocated to which particular document, and which user was authorized to print it. This enables the service provider 304 to associate pen stroke data that it subsequently receives from the digital pen 300 with a particular document, and therefore to process the pen stroke data as required. In addition the service provider 304 can start, establish, or trigger, a service or application that is associated with a particular document, in response to receipt of pen stroke data from the document. On receipt of the pattern definition, the print-on-demand tool 400 combines the pattern with the document content, and forwards the complete document to the printer driver 406, which in turn sends it to the printer for printing.

The service provider can also define a period for which an allocated area of pattern can validly be used. In this case it sends to the user, with the pattern, a definition of that time. Any pen stroke data that it receives within that valid period, the service provider will process. However, if it receives pen stroke data from the allocated pattern outside the period of validity, it does not process it. This means that a specific area of pattern can be re-allocated after the first period of validity has expired. This can be useful where a service provider has only purchased a certain amount of pattern, and needs to be able to re-use it.

Using this basic process, it will be appreciated that there are several possible ways in which the use of pattern by the user 302 can be controlled. Firstly, as mentioned above, the token can define a number of documents for which it is valid. If this is the case, then each document printed using the token amounts to one use of the token. The number of documents is therefore tracked by the service provider 304, and when the token has been used to print as many documents as it was valid for, then it becomes invalid and cannot be used to print any further documents. In a simple system, the number of documents could be the only condition that is attached to the token. However, as also described above, the token can also include, as a further condition of use, a time period within which it is valid, and outside which it cannot be used. This can be combined with the control of the number of documents, or could be used without a limit on the number of documents, so that any number of documents can be printed using the same token, provided they are printed within the specified period.

Controlling the number of documents assumes that each document will require the same amount of pattern. However, this will not always be the case. Where different documents can be printed using the same token, the token can include a limit to the amount of pattern, that it can be used to obtain. In this case the service provider 304 has a record of how much pattern space is required for a document printed from each of a number of document templates. When each document is to be printed, the usage request includes an indication of which type of document is to be printed. The service provider 304 then checks that the token is valid for the required amount of pattern. If it is, it allocates the required amount of pattern to the document, and records how much pattern has been allocated to it. This enables it to meter the actual amount of pattern that has been allocated to documents for each user, using a finer granularity than whole documents or pattern pages. Also as mentioned above, the token can be limited for use with specific document templates, or for specific users or groups of users.

In the example described above, the user pays for the token when purchasing it. This arrangement is particularly suitable where the token entitles the user to print a specific number of documents or to use a particular amount of pattern. It might also be appropriate where the token entitles the user to use as much pattern, and print as many documents, as required within a predetermined time period. However, payment for use of the service provided by the service provider can be arranged in a number of different ways. For example, the user can pay the service provider after having used the pattern, depending on how much pattern has been used. In this case the service provider would be arranged to measure and record the number of documents printed by the user, and then subsequently to bill the user for the use it had made of the pattern. Typically this would be at a regular billing time, such as once a month. Alternatively the user could be billed separately for each time that a document is printed, of for each time a predetermined number of documents is printed, for example the number of documents for which one token is valid.

The actual processes of billing and payment will not be described in detail, as they are well known. For example the initial purchase request from the user to the service provider can be accompanied by an e-cash payment to the service provider.

In this case the service provider checks that the e-cash is sufficient to pay for the service requested. Alternatively credit card type payment can be used, in which case the initial purchase request is accompanied by bank account details and a digital signature of the user. The service provider then forwards those details and the digital signature to the bank which authorises payment from the user's account to the service provider. This method of payment would be particularly suitable where the token is valid for a certain period of time, with no limit, or a high limit, on the number of documents that can be printed.

In the examples just described, the metering of the service is carried out by the service provider. However, it could be client based metering, carried out on the customer system by the print-on-demand tool 400. This in turn could be a distributed metering system in which each print-on-demand tool meters its own use and communicates this to the server, or centralized metering in which a single central software module within the client domain is arranged to retrieve metering data from each of a number of instances of the print-on-demand tool software within the client domain, and communicate it to the server.

It will be appreciated that the embodiments described above provide a secure system in which pattern can be bought and sold, used and re-used. The pattern allocated by the service provider is recorded by the service provider, which can therefore enable the processing of pen stroke data from the documents printed. This enables the service provider to buy pattern from the main pattern allocation server 306 and re-sell it to individual users. Users cannot hack into the system and obtain more pattern than they have paid for because of the security provided by the token factory and the signature and encryption schemes.

A further level of security can also be provided by giving each user a set of credentials, for example an asymmetric key pair that can be used for signature and encryption. Each usage request can then be digitally signed by the user, and the service provider can use the user's public key to check the user's digital signature, thereby ensuring that an unauthorized person cannot obtain pattern by impersonating the user.

In a modification to the system described above, the service provider 304 does not purchase pattern in advance of its use, but acts as a broker selling pattern to the user 302 and other users on behalf of the main pattern allocator 306, and other pattern allocators. In this case, the system operates in the same way as described above, except that whenever the service provider 304 needs to allocate a specific area of pattern to a token or document, it requests the correct amount of pattern from the main pattern allocator, and receives back a definition of the required pattern, which it then forwards to the user. Again, payment can be managed in a number of ways. For example, the user can pay in advance for pattern, or pay each time pattern is used. In either case, the service provider 304 receives payment on behalf of the main pattern allocator 306 and forwards it on to the main pattern allocator. Typically a commission would be paid by the main pattern allocator, or the user, to the service provider.

In a further embodiment of the invention, the pattern is communicated from the service provider 304 to the user 302 in an encrypted format. Referring back to FIG. 2, each dot 130 of the pattern can have one of four positions. This means that the position of each dot can be used to encode two bits of data. The algorithm that generates the pattern is arranged to operate on the basis of co-ordinate positions in pattern space. Given an area defined by its coordinates, the algorithm generates the positions of all of the dots in that area. In order to communicate these positions, the position of each dot is coded as two bits of data, and the order in which the dot positions are coded is also coded in the data. When the pen 300 reads the data, it images an area of 36 dots, and converts the dot positions, taken in a predetermined order, into a sequence of bits. The data that defines the pattern can be encrypted using asymmetric private/public key pairs.

Therefore, when the service provider 304 has selected or obtained an area of pattern to be allocated to a particular document, it encrypts the data defining the pattern in that area using its own private signature key to produce an encrypted pattern definition and then transmits it to the user 302. It then retains a copy of the encrypted pattern area. When the user system 302 prints a document having the allocated pattern on it, the pattern is not in its original form as generated by the original algorithm. The dot positions are changed in a manner defined by the encryption algorithm. This means that the dot positions in the encrypted pattern will not follow the sequence defined by the pattern generating algorithm. Therefore it is not possible to use that algorithm, which may be publicly known, to read the dot positions and convert them back into coordinate references.

When the pen 300 is used on the document, it generates pen stroke data which is sent to the service provider 304. The service provider then decrypts the pen stroke data to a sequence of actual pen stroke positions using the encrypted pattern area. It then uses the decrypted pen stroke data to process the document. It may then also transmit the decrypted pen stroke data back to the user so that the user can use the pen stroke data. In this case it can encrypt the pen stroke data again using the user's public encryption key, so that only the user can decrypt the data. This again prevents third parties from intercepting the pen stoke data.

The advantage of this system is that any third party that intercepts the pen stroke data, sent by the user to the service provider, will not be able to convert it into meaningful pen strokes. This is because the normal algorithm for doing this will not work on the encrypted pattern. This method therefore enables the secure transmission of pen stroke data.

In a further modification to this embodiment, the public/private key pair is selected so that an area, such as a page, of the original pattern can be encrypted using the public key, and positional data derived from a single frame image of six by six dots of the encrypted pattern can be converted back to positional data from the original pattern using the private key. In this case the positional pattern is encrypted by the service provider before being sent to the user, and the user prints the encrypted pattern on the document. Then when the pen is used on the document, each frame of pen stroke data can be decrypted by the service provider to identify the position that it represents. The sequence of decrypted positions can then be used to determine the position of pen strokes on the document in the usual manner.

In an embodiment, the service provider system is arranged to monitor use of pattern, and, optionally, the pattern use monitor is located on the user system.

The invention may also relate to the following aspects:

A service provider system for controlling allocation of areas of data-encoding pattern from a defined pattern space to a user system, the service provider system being arranged to:
receive a certified token from a certification system; and
issue the certified token to the user system thereby authorising the user to use an area of the pattern.

A method of controlling allocation of areas of data-encoding pattern from a defined pattern space, the method comprising:
certifying a token at a certification system, and
issuing the certified token from a service provider system to a user system thereby authorising the user to use an area of the pattern.

A system for producing encrypted pattern for application to a product, the system being arranged to allocate an area of pattern to a document, encrypt data defining the area of pattern so that it defines an area of encrypted pattern, and send the encrypted data to a printing system so that the encrypted pattern can be printed on the product.

A system for interpreting pen stroke data produced using a pen on a product which has encrypted data encoding pattern on it, the system being arranged to receive the pen stroke data, decrypt the pen stroke data, and process the decrypted pen stroke data. Optionally, this system is arranged to use one of an asymmetric public/private key pair for the encryption or decryption.

A method of producing encrypted pattern for application to a product, the method comprising allocating an area of pattern to a document, encrypting data defining the area of pattern so that it defines an area of encrypted pattern, and sending the encrypted data to a printing system so that the encrypted pattern can be printed on the product.

A method of interpreting pen stroke data produced using a pen on a product which has encrypted data encoding pattern on it, the method comprising receiving the pen stroke data, decrypting the pen stroke data, and processing the decrypted pen stroke data.

1. A system for controlling allocation of areas of data-encoding pattern from a defined pattern space, the system comprising:
a service provider system; and
a certification system; wherein
the certification system is arranged to certify a token, and
the service provider system is arranged to issue the certified token to a user thereby authorising the user to use an area of the pattern.

2. A system according to claim 1 wherein the certification system is arranged to certify the token by applying a digital signature to it.

3. A system according to claim 1 wherein the service provider system is arranged to apply a digital signature to the token before forwarding it to the user system.

4. A system according to claim 1 further comprising a user system, wherein the user system is arranged to submit the token to the service provider system when it is required to use an area of the pattern.

5. A system according to claim 4 wherein the user system is arranged to apply a digital signature to the token before submitting it.

6. A system according to claim 1 wherein the token defines an amount of pattern space which the user system can use.

7. A system according to claim 1 wherein the token defines a specific area of the pattern space for use by the user system.

8. A system according to claim 1 wherein the service provider system is arranged to communicate to the user a definition of a specific area of pattern space in response to submission of the token to the service provider system.

9. A system according to claim 1 wherein the service provider system is arranged to allocate specific areas of the pattern space to the user.

10. A system according to claim 1 wherein the service provider system is arranged, in response to submission to it of the token, to request a specific area of pattern from a pattern allocation system.

11. A system according to claim 1 wherein the service provider system is arranged to communicate to the user conditions of use of the token.

12. A system according to claim 11 wherein the service provider is arranged to include a definition of the conditions of use in the token.

13. A system according to claim 11 wherein the conditions of use include a limit on the time at which pattern can be used.

14. A system according to claim 11 wherein the conditions of use include a limit to the number of specific pattern areas that can be used.

15. A system according to claim 11 wherein the conditions of use include a limit to the types of document to which the pattern area can be allocated.

16. A system according to claim 1 wherein the user system and the service provider system are arranged to enable payment for the pattern on behalf of a user of the user system.

17. A system according to claim 16 wherein the service provider is arranged to issue the token only on receipt of payment.

18. A system according to claim 16 arranged to monitor use of pattern by the user system thereby to enable payment for the pattern after it has been used.

19. A system according to claim 18 wherein the service provider system is arranged to monitor use of pattern.

20. A service provider system for controlling allocation of areas of data-encoding pattern from a defined pattern space to a user system, the service provider system being arranged to:
receive a certified token from a certification system; and
issue the certified token to the user system thereby authorising the user to use an area of the pattern.
